(19) United States
(12) Patent Application Publication
(10) Pub. No.: US 2008/0022598 A1
(43) Pub. Date: Jan. 31, 2008

(54) Brace part for a driving rod brace

(75) Inventor: Mario Polster, Suhl (DE)

Correspondence Address: YOUNG & THOMPSON, 745 SOUTH 23RD STREET, 2ND FLOOR, ARLINGTON, VA, 22202, US

(73) Assignee: AUG WINKHAUS GMBH & CO. KG, TEIGTE (DE)

(21) Appl. No.: 11/785,823

(22) Filed: Apr. 20, 2007

(30) Foreign Application Priority Data
Jul. 25, 2006 (DE) 10 2006 000 369.1

(51) Int. Cl. E05D 15/26

(52) U.S. Cl. 49/253

(57) ABSTRACT

In a brace part for the driving rod brace (4) of a window, the housing (10) is attached to a jacket rail (9) via brackets (16, 17). The jacket rail (9) has recesses (18, 19) through which the brackets (16, 17) are guided. The brackets (16, 17) with bends (22, 23) extend behind shoulders (20, 21) which are located in the recesses (18, 19). In this way the housing (10) is positioned especially exactly on the jacket rail (9) and avoids components which project over the jacket rail (9).

The invention relates to a brace part for a driving rod brace which is designed for locking a wing in a frame with a stationary jacket rail, with a driving rod which is guided to move lengthwise on the jacket rail and with a housing attached to the jacket rail.

These brace parts are used for example in driving rod locks of doors in which secondary locks are triggered from a main lock via a driving rod. In the housing one or two driving rods are guided to move lengthwise. The housing can hold a reversing mechanism for coupling of two driving rods so that the driving rods are driven in opposite directions.

These brace parts are known for example from EP 1 039 081 B1. In this brace part the housing has projecting rivet tongues which penetrate into side notches of the jacket rail. The rivet tongues are fastened in the notches and thus hold the housing on the jacket rail. In this way however only very low forces can be transmitted from the housing to the jacket rail. The housing can thus be very easily detached from the jacket rail.

DE 600 01 627 T2 discloses driving rod gearing in which a sleeve for guiding the driving rod on the jacket rail extends around the end of the jacket rail. But this leads to a shoulder on the side of the driving rod brace which is visible in the mounted state. Moreover the continuous jacket rail requires an interruption for installing the sleeve on one end of the jacket rail section. Thus this configuration can also transfer only small forces from the sleeve to the jacket rail.

Welding the housing to the jacket rail has already been imagined. But this leads to an adverse optical effect on the visible section of the jacket rail and moreover to welding distortion of the brace part.

The object of the invention is to develop the brace part of the initially named type such that it enables simple and exact positioning of the housing on the driving rod.

This object is achieved as claimed in the invention in that the jacket rail has recesses for holding the brackets of the housing, that the recesses have one shoulder each and that the brackets with a bend extend behind the shoulders.

The housing is reliably held positively on the jacket rail by this configuration. In this way welding distortion of the brace part as claimed in the invention is safely prevented. The bends enable transmission of high holding forces. Thus the housing is reliably connected to the driving rod.

An adverse optical effect on the region of the jacket rail which is visible in the mounted state can be easily avoided according to one advantageous development of the invention when the brackets with their side facing away from the shoulders end flush with the surface of the jacket rail.

Flush termination of the bends with the visible surface of the jacket rail can be easily achieved according to another advantageous development of the invention when the distance of the visible surface of the jacket rail corresponds to the shoulder in the recess of the wall thickness of the housing.

The recesses could for example be made as notches in the side edge of the jacket rail. The brace part as claimed in the invention however has especially high stability when the recesses are made as openings in the jacket rail. Another important advantage of this configuration consists in that one side edge of the recesses which is opposite the shoulder can laterally support the brackets. This leads to an especially exact positioning of the housing relative to the jacket rail.

Loading or deformation of the lateral outside edge of the jacket rail when the housing is being mounted or by loads on the housing in operation of the driving rod brace can be easily avoided according to another advantageous development of the invention when the shoulder is located on the edge of the recess away from the lateral outside edge of the jacket rail and when the edge of the recess near the lateral outside edge of the jacket rail is made for lateral support of the bracket. By this configuration the bends of opposing brackets point toward one another so that loads on the housing are diverted into the middle region of the jacket rail. This leads to a further increase in the exactness of positioning of the housing relative to the jacket rail.

Production of the brace part as claimed in the invention is made especially simple when the shoulders of the recesses are produced by upsetting. Furthermore the jacket rail for this reason has especially high stability.

The especially high exactness of positioning of the housing on the jacket rail is especially advantageous when the housing holds at least one bearing axis of a gear for coupling two driving rods which work in opposite directions. Preferably the housing for this purpose has a hole for holding the bearing axis.

The brace part as claimed in the invention is made structurally especially simple and can be economically produced when the housing in cross section is bent in a U-shape and has a base and legs projecting from the base and when the ends of the legs facing away from the base have brackets.

It contributes to further increasing the stability of the brace part as claimed in the invention when the ends of the legs facing away from the base have support edges for supporting the housing on the jacket rail.

It contributes to further increasing the stability of the brace part as claimed in the invention when the housing is made of steel.

The invention allows numerous embodiments. To further illustrate its basic principle, two are shown in the drawings and are described below.

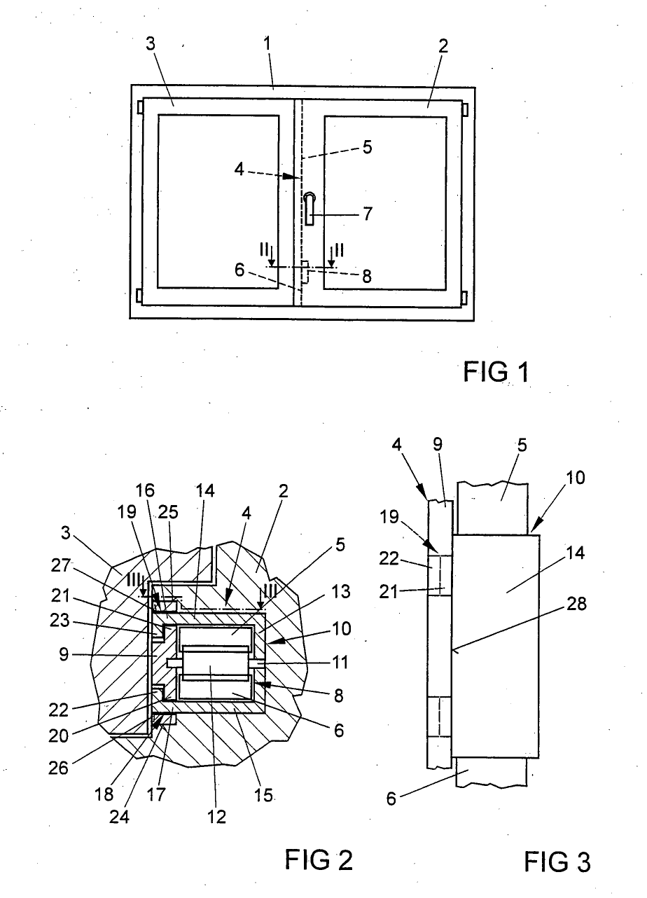

FIG. 1 shows a two-casement window with a driving rod brace,

FIG. 2 shows highly enlarged a sectional representation through one component region of the window with the driving rod brace from FIG. 1 along line II-II,

FIG. 3 shows a brace part of the driving rod brace from FIG. 2 in a sectional representation of the window along line III-III,

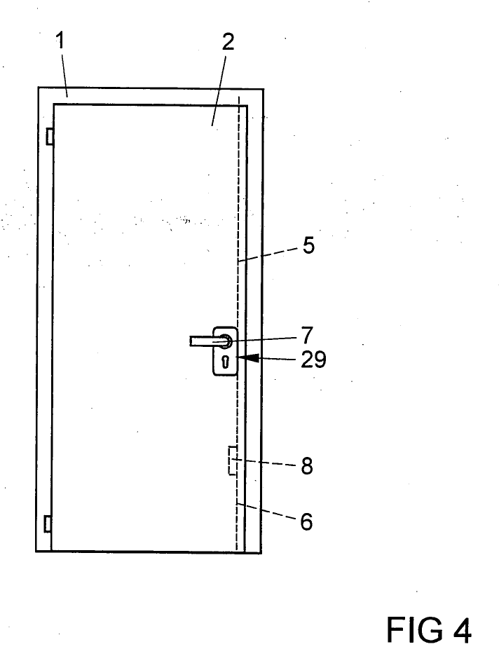

FIG. 4 shows a door with a main lock and a driving rod brace.

FIG. 1 shows a two-casement window which has the brace part as claimed in the invention without a mullion with a frame 1 and a first casement 2 and a second casement 3. The casements 2, 3 are supported to be able to pivot on the frame 1. The window has a driving rod brace 4 with two driving rods 5, 6 which run in opposite directions for locking the casements 2, 3 in the frame 1. The driving rod brace 4 can be driven by a handle 7. The movements of the driving rods 5, 6 are coupled in gearing 8.

FIG. 2 shows highly enlarged a sectional representation through the window in the region of the gearing 8 of the driving rod brace 4 from FIG. 1 along line II-II. The driving rod brace 4 has a stationary jacket rail 9 which is located on one of the casements 2. The housing 10 of the gearing 8 is attached to the jacket rail 9. The bearing axis 11 of the gear 12 of the gearing 8 which coupled to the two driving rods 5, 6 is supported in the housing 10. In this way, when one of the driving rods 5 is driven by the handle 7 the other of the driving rods 6 is moved oppositely. The two driving rods 5, 6 are each guided to move lengthwise in the housing 10.

The housing 10 is bent in a U-shape and has a base 13 and legs 14, 15 which project from the base 13. There are brackets 16, 17 which penetrate into the recesses 18, 19 of the jacket rail 9 on the ends of the legs 14, 15 facing away from the base 13. The jacket rail 9 has shoulders 20, 21 which have been produced by upsetting of the material of the jacket rail 9, which are located in the recesses 18, 19, and behind which the bends 22, 23 of the brackets 16, 17 of the housing 10 extend. The recesses 18, 19 of the jacket rail 9 are made as openings. Furthermore, the recesses 18, 19 near the lateral outside edges 24, 25 of the jacket rail 9 have edges 26, 27 for lateral support of the brackets 16, 17. The brackets 16, 17 opposite one another are bent toward one another.

As show in FIG. 3 in a sectional representation through a component region of the window from FIG. 2 along the line III-III, the legs 14 have support edges 28 for support on the jacket rail 9. The support edges 28 of the legs 14, 15 are drawn against the jacket rail 9 by the bends 22, 23 of the brackets 16, 17 which are shown in FIG. 2 and hold the housing 10 on the jacket rail 9.

FIG. 4 shows a door with a main lock 29 for triggering the driving rod brace 4. The components of the window from FIG. 1 and the door from FIG. 4 which correspond to one another are identified with the same reference numbers. The main lock 29 locks the wing 2 of the door in the frame 1 and drives the two driving rods 5, 6 which move in opposite directions. The movements of the driving rods 5, 6 are coupled by the gearing 8. The gearing 8 is made as shown in FIGS. 2 and 3.

1. Brace part for a driving rod brace which is designed for locking a wing in a frame with a stationary jacket rail, with a driving rod which is guided to move lengthwise on the jacket rail and with a housing attached to the jacket rail, characterized in that the jacket rail (9) has recesses (18, 19) for holding the brackets (16, 17) of the housing (10), that the recesses (18, 19) have one shoulder (20, 21) each and that the brackets (16, 17) with a bend (22, 23) extend behind the shoulders (20, 21).

2. Brace part as claimed in claim 1, wherein the brackets (16, 17) with their side facing away from the shoulders (20, 21) end flush with the surface of the jacket rail (9).

3. Brace part as claimed in claim 2, wherein the distance of the visible surface of the jacket rail (9) corresponds to the shoulder (20, 21) in the recess (18, 19) of the wall thickness of the housing (10).

4. Brace part as claimed in claim 1, wherein the recesses (18, 19) are made as openings in the jacket rail (9).

5. Brace part as claimed in claim 1, wherein the shoulder (20, 21) is located on the edge (26, 27) of the recess (18, 19) away from the lateral outside edge (24, 25) of the jacket rail (9) and wherein the edge (26, 27) of the recess (18, 19) near the lateral outside edge (24, 25) of the jacket rail (9) is made for lateral support of the bracket (16, 17).

6. Brace part as claimed in claim 1, wherein the shoulders (20, 21) of the recesses (18, 19) are produced by upsetting.

7. Brace part as claimed in claim 1, wherein the housing (10) holds at least one bearing axis (11) of the gear (12) for coupling two driving rods (5, 6) which work in opposite directions.

8. Brace part as claimed in claim 1, wherein the housing (10) in cross section is bent in a U-shape and has a base (13) and legs (14, 15) projecting from the base (13) and wherein the ends of the legs (14, 15) facing away from the base (13) have brackets (16, 17).

9. Brace part as claimed in claim 8, wherein the ends of the legs (14, 15) facing away from the base (13) have support edges (28) for supporting the housing (10) on the jacket rail (9).

10. Brace part as claimed claim 1, wherein the housing (10) is made of steel.

11. Brace part as claimed in claim 2, wherein the recesses (18, 19) are made as openings in the jacket rail (9).

12. Brace part as claimed in claim 2, wherein the shoulders (20, 21) of the recesses (18, 19) are produced by upsetting.

13. Brace part as claimed in claim 2, wherein the housing (10) holds at least one bearing axis (11) of the gear (12) for coupling two driving rods (5, 6) which work in opposite directions.

14. Brace part as claimed in claim 2, wherein the housing (10) in cross section is bent in a U-shape and has a base (13) and legs (14, 15) projecting from the base (13) and wherein the ends of the legs (14, 15) facing away from the base (13) have brackets (16, 17).

15. Brace part as claimed claim 2, wherein the housing (10) is made of steel.
